(19) United States
(12) Patent Application Publication
(10) Pub. No.: US 2025/0291572 A1
(43) Pub. Date: Sep. 18, 2025

(54) Statistical Analysis With Influence Factor For Implementing Candidate Applications

(71) Applicant: Oracle International Corporation, Redwood Shores, CA (US)

(72) Inventors: Pietro Giuseppe Di Stefano, London (GB); Theresa Maria Offwood-Le Roux, London (GB); Xiaoxue Zhao, London (GB); Hugo Alexandre Pereira Monteiro, London (GB)

(73) Assignee: Oracle International Corporation, Redwood Shores, CA (US)

(21) Appl. No.: 18/605,245

(22) Filed: Mar. 14, 2024

(51) Int. Cl. G06F 8/65; G06F 8/30; G06F 8/77

(52) U.S. Cl. CPC G06F 8/65; G06F 8/30; G06F 8/77

(57) ABSTRACT

Techniques for modifying application-generating code are disclosed. A system determines if a change to an application-generating code module results in a statistically significant change in the performance of applications generated by the module. The system makes the determination by comparing performance metrics of multiple applications generated by an un-changed application-generating code module to performance metrics of multiple applications generated by a changed application-generating code module. The system compares the performance metrics by generating distributions representing the respective performance metrics. The system generates the distributions by fitting the performance metrics to a statistical algorithm including an inter-application influence factor. The influence factor modifies the statistical model by converting a change in the shape of the distribution from (a) around a center of the performance metric distribution to (b) a shift of the center of the performance metric distribution toward a clustering of measured performance metric values.

### TECHNICAL FIELD

The present disclosure relates to evaluating and selecting candidate applications for implementation in an execution environment. In particular, the present disclosure relates to applying a statistical analysis with an influence factor to candidate applications generated by a set of application generating code to determine whether or not to implement candidate modifications to the application generating code in an execution environment.

### BACKGROUND

Continuous integration/continuous delivery (CI/CD) is a software development practice where developers frequently integrate their code changes into a shared repository that then triggers automated building, testing, and deployment of the software application. CI/CD can significantly boost developer productivity by continuously integrating and deploying small code increments. However, applying this approach to machine learning development presents challenges due to the statistical nature of model performance evaluation. Since model performance cannot be directly tested during development, it is required to use proxies, such as shadow deployment or test sets. However, these have limitations, like high cost, code forking, and statistical uncertainty. Additional complications come from needing to evaluate performance on multiple metrics, sub-populations, and customer groups. Practitioners need to accurately estimate if a code change improves or worsens a performance metric.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for modeling changes to application-generating code based using statistical modeling in accordance with one or more embodiments;

FIG. 3 illustrates an example distribution comparison in accordance with one or more embodiments;

FIG. 4 illustrates an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. APPLICATION MODELING ARCHITECTURE
3. MODELING CHANGES TO APPLICATION-GENERATING CODE BASED ON STATISTICAL MODEL WITH INFLUENCE FACTOR
4. EXAMPLE EMBODIMENT
5. PRACTICAL APPLICATIONS, ADVANTAGES, AND IMPROVEMENTS
6. COMPUTER NETWORKS AND CLOUD NETWORKS
7. HARDWARE OVERVIEW
8. MISCELLANEOUS; EXTENSIONS

### 1. General Overview

One or more embodiments determine if a change to application-generating code results in a statistically significant change in the performance of applications generated by the code. For example, a system may determine if changing features used by a machine learning engine to train machine learning models results in a statistically significant and positive change in the performance of the machine learning models. The system makes the determination by comparing performance metrics of multiple applications generated by the unchanged application-generating code to performance metrics of multiple applications generated by the changed application-generating code. The system compares the performance metrics by generating distributions representing the respective performance metrics. The system generates the distributions by fitting the performance metrics to a statistical algorithm including an inter-application influence factor. The influence factor modifies the statistical model by converting a change in the shape of the distribution from (a) around a center of the performance metric distribution to (b) a shift of the center of the performance metric distribution toward a clustering of measured performance metric values. The influence factor represents a correlation between the application-under-test and additional applications generated by the modified application-generating code. If the system determines, based on comparing the distributions, that a change to the application-generating code module is (a) positive and (b) statistically significant, the system implements the modified application-generating code module in an execution environment.

One or more embodiments described in this Specification and/or recited in the claims may not be included in this General Overview section.

### 2. Application Modeling Architecture

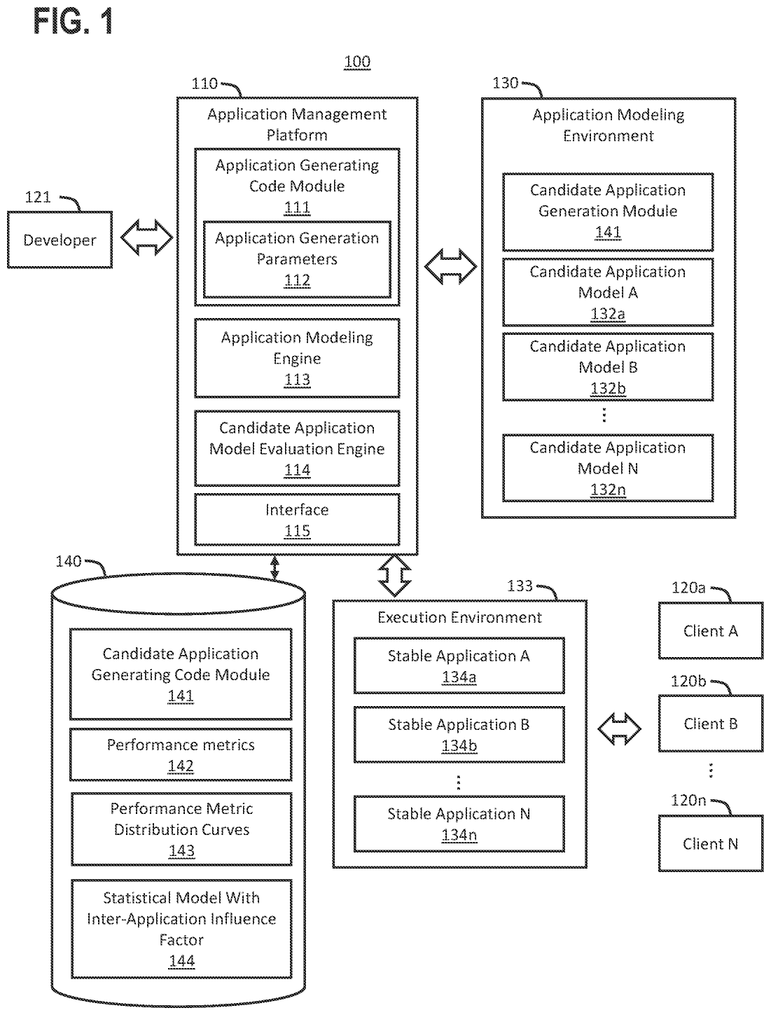

FIG. 1 illustrates a system 100 in accordance with one or more embodiments. As illustrated in FIG. 1, system 100 includes an application management platform 110 and a data repository 140. The system further includes an application-modeling environment 130 and an execution environment 133. A developer 121 communicates with the application management platform 110 to generate candidate applications and modifications to application generating code. Clients 120a, 120b, . . . 120n execute the stable applications 134a, 134b, . . . 134n in the execution environment 133. In one or more embodiments, clients 120a-120n are tenants accessing a shared computing resource. A tenant is a corporation, organization, enterprise, or other entity that accesses a shared computing resource such as the application in execution environment 133. In an embodiment, clients 120a-120n are independent from one another. A business or operation of client 120a is separate from a business or operation of client 120b and 120n.

In one or more embodiments, the system 100 may include more or fewer components than the components illustrated in FIG. 1. The components illustrated in FIG. 1 may be local to or remote from one another. The components illustrated in FIG. 1 may be implemented in software and/or hardware. Components may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

The application management platform 110 includes an application generating code module 111. The application generating code module includes a set of software code executing on computing hardware that generates versions of applications based on sets of input data provided to the code module. Providing different sets of input data to the application generating code module 111 results in generating different applications or application versions. The application generating code module 111 is characterized by application generation parameters 112. Modifications to the application generation parameters 112 result in modifications to applications that are generated by the application generating code. The application generation parameters 112 include, for example, features, processes, rules, and values. Features include types or categories of data for the input data that is received to generate applications. For example, a set of input data may include a set of 1,000 features. The input data may include a value for each feature. The values may include, for example, binary values, numerical values that are non-binary, and alphanumeric values. The application generating code module 111 may perform processes based on the input values to generate a set of output values. The processes may be specified in a set of rules. The set of rules specifies the operations to be performed, conditions to be met to perform the operations, and an order for performing the operations. Applying an input data set to the application generating code module causes the system to execute the corresponding processes and rules based on particular features and values to generate a version of an application.

According to an example embodiment, the application-generation operations of the application generating code module 111 are accessible through an application programming interface (API). The API may specify types of input data that may be provided to the application generating code module 111 to generate a version of an application. The API may specify the number and type of features that may be included in a data set.

The application management platform 110 manages a set of applications 134a-134n executing in an execution environment 133. In one example embodiment, the execution environment 133 is a cloud-computing environment. The applications 134a-134n may be stored in one or more servers in the cloud-computing environment. Clients 120a-120n may access respective applications 134a-134n via a network. In an alternative embodiment, clients 120a-120n may manage private systems and networks. The application management platform 110 may deliver applications 134a-134n to execute on the private systems and networks of the clients 120a-120n.

Herein, stable applications refer to applications that have been evaluated and satisfy implementation criteria. For example, if the applications are machine learning models, the models have been evaluated and meet particular performance criteria such as prediction accuracy. In an alternative example where the applications are executable software artifacts, the stable applications may refer to sets of software code that have passed compilation and quality tests. The code may be stored as executable artifacts accessible by clients. While FIG. 1 illustrates stable applications 134a-134n implemented in an execution environment 133, in one or more embodiments, the system 100 stores copies of applications 134a-134n in a data repository 140. Clients 120a-120n may access the applications 134a-134n by accessing the data repository 140. In addition, the application management platform 110 may evaluate potential modifications to applications and application generating code using the applications 134a-134n stored in the data repository 140.

A developer 121 may generate a candidate application generating code module 141. The candidate application generating code module 141 includes one or more modifications from a stable application generating code module 111. For example, a developer may recommend adding or removing one or more features from among a set of features used to train machine learning models to generate applications. As another example, a developer may recommend adding one or more processes, such as an authentication process, an encryption process, a data processing process, or a performance optimization process to applications generated by the application generating code module 111. The application management platform 110 stores the candidate application generating code module 141 in the data repository 140.

The application modeling engine 113 applies a set of input data to the candidate application generating code module 141 to generate a set of candidate application models, referred to in FIG. 1 as candidate application model A 132a, candidate application model B 132b, and . . . candidate application model N 132n. The candidate application models 132a-132n are stored in the data repository 140 and evaluated in an application modeling environment 130. The application modeling environment 130 may be implemented as a virtual environment. In other words, while the applications 134a-134n may interface with software applications and hardware devices in the execution environment 133, the application modeling environment 130 may generate input values to the application models 132a-123n that mimic input values that would be generated by the software applications and the hardware devices. For example, an application 134a in the execution environment 133 may receive data sets of sensor data as input from devices operating in a computing environment. The application modeling environment 130 may digitally generate values that mimic digital and analog measured sensor values but that do not result from any system measurements in a computing environment.

The candidate application model evaluation engine 114 evaluates the candidate application models 132a-132n in the application modeling environment 130. The candidate application model evaluation engine 114 generates a set of performance metrics 142 for the candidate application models 132a-132n. The candidate application model evaluation engine 114 generates the performance metrics 142 by applying a test data set to the models 132a-132n.

Examples of performance metrics include classification-type metrics, regression-type metrics, clustering-type metrics, ranking-type metrics, anomaly-detection-type metrics, and multi-class-type metrics. For example, the system may determine a set of classification-type performance metrics including accuracy, precision, recall, an F1 score, and/or an area under a receiver operating characteristic curve (AUC-ROC). The accuracy is a measure of a proportion of correctly classified instances. The precision is the number of true positives (e.g., classifications identified correctly as “positive”) divided by the sum of true positives and false positives (e.g., classifications identified incorrectly as “positive”). The recall is calculated by the number of true positives divided by the sum of true positives and false negatives. The F1 score is the harmonic mean of precision and recall. The AUC-ROC measures the ability of a model to discriminate between positive and negative instances across different thresholds.

In one or more embodiments, the candidate application model evaluation engine 114 generates the performance metrics 142 by generating multiple different metrics for the same data set and the same candidate model to generate sets of full metric distributions. For example, the system generates a full metric distribution for a candidate model by measuring the accuracy, precision, recall, F1 score, and AUC-ROC when input data sets are provided to the candidate model. As another example, the system may generate a full metric distribution for a candidate model by measuring the MSE, MAE, and R2 for the candidate model.

In one or more embodiments, the candidate application model evaluation engine 114 generates the performance metrics 142 by applying a non-parametric bootstrap statistical method to generate the performance metrics. The system applies the non-parametric bootstrap statistical method by repeatedly resampling from the original dataset with replacement to simulate the sampling distribution of a performance metric. For example, in an embodiment where the application models 132a-132n are machine learning models, the original dataset may be the test data that machine learning models are evaluated on. This is a “sample” from some larger population that the models will be applied to. The candidate application model evaluation engine 114 resamples with replacement by randomly drawing data points from the test set to create new test sets of the same size. Performing the resampling process many times creates many variations (i.e., samples) of test sets even though they come from the original test data. The candidate application model evaluation engine 114 determines the sampling distribution of performance metrics 142 by determining how much the performance metric varies across the resampled test sets. In one or more embodiments, the resampling process simulates repeatedly collecting new test sets and evaluating model metrics on the different test sets. In addition to applying the non-parametric bootstrap statistical method, the candidate application model evaluation engine 114 further takes the point estimate of the original test data to compute the set of performance metrics 142 directly on the original test data.

The candidate application model evaluation engine 114 fits the performance metrics 142 to a statistical model 144 including an inter-application influence factor to generate a distribution curve 143 for a candidate application model. The candidate application model evaluation engine 114 further obtains a distribution curve 143 for a corresponding stable application. For example, the candidate application model evaluation engine 114 applies a first test data set to both the application model 132a and the stable application 134a to generate distribution curves 143 for the respective application model 132a and stable application 134a. In one embodiment, the candidate application model evaluation engine 114 accesses stored performance metrics data 142 and/or distribution curve data 143 for stable applications 134a-134n from the data repository 140. In other words, when the candidate application model evaluation engine 114 determines that candidate applications meet implementation criteria, the application management platform 110 may store the applications, corresponding performance metrics data 142, and distribution curve data 143 in a data repository 140 for later implementation and analysis.

In one or more embodiments, the candidate application model evaluation engine 114 fits the performance metrics 142 for a candidate application model 132a-132n to a statistical model 144 by performing null hypothesis testing on the metrics data. The null hypothesis testing quantifies the likelihood that changes to the application generating code module, as represented by candidate application performance metrics, is statistically significant. In other words, the null hypothesis testing quantifies a probability value representing whether the changes to the application generating code model result in performance metrics changes that are more than just the noise that would result from random changes to the application generating code module. The stable state, or current state, of the application generating code module is represented by a set of performance metrics that correspond to stable applications such as applications currently implemented in an execution environment.

In one or more embodiments, the statistical model 144 is a Bayesian-type statistical model that includes a parameter (referred to in the present specification as influence factor, M) that modifies a distribution of the performance metric data to convert a change in the shape of the distribution from (a) around a center of the performance metric distribution to (b) a shift of the center of the performance metric distribution toward a clustering of measured performance metric values. In embodiments, the influence factor, M, represents a correlation between the performance improvement (or deterioration) of a set of applications under test and a corresponding set of stable applications.

The candidate application model evaluation engine 114 compares a distribution for the performance metrics for a candidate application model with a distribution for the performance metrics for a corresponding stable application. The candidate application model evaluation engine 114 infers from the distribution for the candidate application model the performance of the candidate application generating code module 141 that is the source of the application model. If the candidate application model evaluation engine 114 determines that the modeled modification to the application generating code meets the implementation criteria, the application management platform may implement the candidate application model in the execution environment 133. For example, the application management platform 110 may replace the stable applications 134a-134n with applications corresponding to the models 132a-132n. Additionally, or alternatively, the application management platform 110 may store a set of modified applications generated by a set of modified application generating code in a data repository 140. The application management platform 110 may implement the applications stored in the repository in an execution environment 133 when certain conditions are met. For example, the application management platform 110 may update applications for clients at predefined intervals such as at monthly intervals. Alternatively, the application management platform 110 may push sets of modified applications to client devices to replace currently executing applications based on achieving predefined performance improvement values. As an example, the system may refrain from pushing modified applications to client devices to replace currently executing applications until the modified applications correspond to at least a 5% improvement across a set of performance metrics.

In one or more embodiments, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Further, a data repository 140 may be implemented or executed on the same computing system as application management platform 110. Additionally, or alternatively, a data repository 140 may be implemented or executed on a computing system separate from application management platform 110. The data repository 140 may be communicatively coupled to application management platform 110 via a direct connection or via a network.

Information describing candidate application generating code module 141, performance metrics 142, distribution curves 143, and statistical models 144 may be implemented across any of components within the system 100. However, this information is illustrated within the data repository 140 for purposes of clarity and explanation.

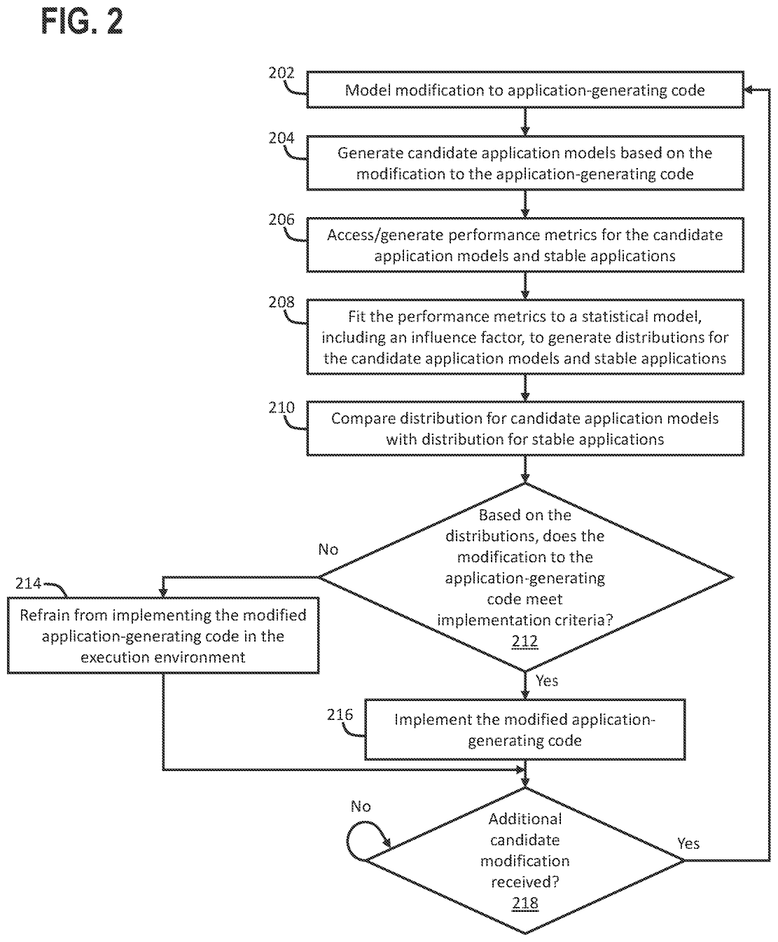

In one or more embodiments, application management platform 110, application generating code module 111, application generation parameters 112, application modeling engine 113, and candidate application model evaluation engine 114 refer to hardware and/or software configured to perform operations described herein for modeling candidate applications based on modifications to application generating code using a statistical model. Examples of operations for modeling changes to application-generating code based on statistical model with influence factor are described below with reference to FIG. 2.

In an embodiment, the application management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 115 refers to hardware and/or software configured to facilitate communications between a user, such as developer 121 and clients 120a-120n, and the application management platform 110. Interface 115 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 115 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 115 is specified in one or more other languages, such as Java, C, or C++.

### 3. Modeling Changes to Application-Generating Code Based on Statistical Model With Influence Factor

FIG. 2 illustrates an example set of operations for initiating operations based on determining a context for an operation request in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

According to an embodiment, a system models modifications to an application generating code module (Operation 202). In one embodiment, the system stores a model of the modified application-generating code in a data repository prior to implementing the application-generating code in an execution environment. The application generating code module includes a set of software code executing on computing hardware that generates versions of applications based on sets of input data provided to the code module. Providing different sets of input data to the application generating code results in generating different applications or application versions. The application generating code module is characterized by application generation parameters. Modifications to the application generation parameters result in modifications to applications that are generated by the application generating code. The application generation parameters include, for example, features, processes, rules, and values. Applying an input data set to the application generating code module causes the system to execute the corresponding processes and rules based on particular features and values to generate a version of an application. The application version, in turn, is characterized by application parameters. Users, client devices, and/or other applications may execute applications by providing input data to the applications. The application parameters determine (a) processes executed by the application version and (b) output values generated by the application version.

The application generating code module may generate executable applications, such as software artifacts and models. When the executable application is provided with a set of input data, the application generates a set of output data. Modifying the application generating parameters of the application generating code module may include modifying the criteria for selecting or adjusting application parameters. Accordingly, modifying the application generating parameters results in modifying output values generated by applications for a particular set of input data. In other words, providing the same set of input data to a first version of an application and a second, modified, version of the application results in a different set of output values.

For example, the application generating code module may be a machine learning engine. The machine learning engine may train a neural network by selecting sets of parameters, such as offset values and coefficient values for neurons of the neural network. The machine learning engine trains the neural network with training data sets.

Modifying the application generating parameters in the application generating code (i.e., in the machine learning engine) may include, for example, tuning hyperparameters, such as the learning rate, the number of layers in the neural network, the number of neurons per layer, or the batch size of a training data set that is used to train the neural network. According to another example, modifying the application generating code includes feature engineering, such as adding, removing, or transforming input features. Examples of feature engineering include feature normalization, principal component analysis (PCA), and the inclusion of polynomial features in a feature set. According to another example, modifying the application generating code includes adding a regularization term to models to reduce overfitting. In the regularization process, the system may impose constraints and penalties on model parameters (e.g., coefficients and weights) during the training to smooth the model weights to avoid extreme values that perfectly fit the noise and idiosyncrasies of the training set but that may not pick up on true and generalizable patterns. According to another example, modifying the application generating code includes performing model compression on the application generating code. The system may apply pruning, quantization, or knowledge distillation techniques to shrink machine learning models for faster inference times.

According to yet another example, modifying the application generating code includes modifying a loss function applied to models during training to either change the loss function to a different loss function or to modify the performance of a presently applied loss function. For example, a system may assign different weights to different data points or types of errors. The system may give more weight to hard examples or outlier cases that the model struggles with. The system may replace a simple loss function with one that is less sensitive to outliers, such as Huber Loss or Quantile Loss. The system may down-weight the loss contribution from easy examples and focus training on hard, misclassified cases. The system may add L1/L2 weight regularization components to the loss to induce sparsity and prevent overfitting.

While the above application parameters are presented in the context of a neural network, embodiments are not limited to a neural network. For example, in one or more embodiments, the application generating code module is a machine learning engine that trains another type of machine learning model, including, but not limited to, a linear regression-type model, a logistic regression-type model, a decision tree-type model, a naïve Bayes classifier-type model, a K-nearest neighbors-type model, and a support vector machine-type model.

Additionally, or alternatively, the application generating code module may generate an executable software artifact. Application parameters may include processes and values used by the software to generate output values based on a set of input values. For example, a system may modify a set of application generating parameters in the application generating code module to add an authentication process to a data access process implemented by a software application. As a simple example, the application generating code module receives as input data (a) a set of data to be accessed, (b) a requestor of the data, and (c) authentication data associated with the requestor. The application generating code module generates the executable software artifact to include the processes required to (a) receive a data request and authentication data, (b) execute an authentication process, and (c) execute a data access process. The application generating code module may generate two different applications for two different clients. One application may include different information for data to be accessed and authority levels required to access the data than the other application. In other words, the application generating code module generates different executable software code for different clients based on the clients providing different application configuration data to the application generating code module.

The system generates candidate application models based on the modifications to the application-generating code (Operation 204). The system generates a candidate application model by applying a set of application configuration input data to the modified application generating code module. The system generates multiple candidate application models by applying multiple sets of different application configuration input data to the same modified application generating code module. In one embodiment, the system stores a model of the modified application generating code in a data repository prior to implementing the application generating code in an execution environment. The system may generate a set of application models by applying sets of application configuration input data to the model of the modified application generating code.

For example, in the example embodiment where the application generating code module is a machine learning engine, the modified machine learning engine trains a first candidate machine learning model with a first set of training data. The same modified machine learning engine trains a second candidate machine learning model with a second set of training data. As an example, an enterprise may test the performance of a machine learning model for different demographic groups. Different sets of training data may correspond to individuals of different ethnicities, income levels, ages, genders, geographic locations, or any other demographic class. Additionally, or alternatively, different data sets used to train different machine learning models may be from different organizations, such as companies, different time periods, or originating from different types of data sources, such as documents, images, records, or observed measurements.

The system generates performance metrics for the set of candidate application models and accesses performance metrics for a set of stable applications (Operation 206). For example, the set of stable applications may be a set of applications implemented in client systems. These may include applications that have been implemented in an execution environment, applications that have been delivered to client systems for implementation, and applications that have been successfully compiled, tested, and stored as executable artifacts. If a system generates four different machine learning models for four different client systems, the stable models are models that are currently used by the four different client systems. Similarly, if a system generates four different software applications for four different client systems, the stable applications are applications that are currently used by the four different client systems.

Examples of performance metrics include classification-type metrics, regression-type metrics, clustering-type metrics, ranking-type metrics, anomaly-detection-type metrics, and multi-class-type metrics. For example, the system may determine a set of classification-type performance metrics including accuracy, precision, recall, an F1 score, and/or an area under a receiver operating characteristic curve (AUC-ROC). The accuracy is a measure of a proportion of correctly classified instances. The precision is the number of true positives (e.g., classifications identified correctly as “positive”) divided by the sum of true positives and false positives (e.g., classifications identified incorrectly as “positive”). The recall is calculated by the number of true positives divided by the sum of true positives and false negatives. The F1 score is the harmonic mean of precision and recall. The AUC-ROC measures the ability of a model to discriminate between positive and negative instances across different thresholds.

Examples of regression-type metrics include mean squared error (MSE), mean absolute error (MAE), and R-squared value (R2). The MSE measures the average of squared differences between predicted and actual values. The MAE measures the average absolute differences between predicted and actual values. The R2 measures the proportion of variance in a dependent variable that is predictable from independent variables.

Examples of clustering-type metrics include a silhouette score and a Davies-Bouldin Index. Examples of ranking metrics include a mean reciprocal range (MRR) and a Normalized Discounted Cumulative Gain (NDGG). Examples of anomaly detection metrics include precision at K and recall at K. Precision at K measures a precision value calculated considering the top K predicted instances as anomalies. An example of a multi-class metric is a macro/micro-average of precision, recall, and F1 score.

In one or more embodiments, generating the performance metrics includes determining an estimated time difference between a first time required to perform a particular set of operations using a candidate application model generated using the modified application generating code module and a second time required to perform the particular set of operations using the a stable application generated using a stable application generating code module. For example, the stable application generating code module may be a module that is presently implemented in an execution environment to generate applications for use by clients. Additionally, or alternatively, generating the performance metrics may include determining an estimated time difference between a first time required to perform a particular set of operations using the candidate application model and a second time required to perform the particular set of operations without using any application generated by any application generating code module (including the stable application generating code module and the modified application generating code module).

In one or more embodiments, generating the performance metrics includes generating multiple different metrics for the same data set and the same candidate model to generate sets of full metric distributions. For example, the system generates a full metric distribution for a candidate model by measuring the accuracy, precision, recall, F1 score, and AUC-ROC when input data sets are provided to the candidate model. As another example, the system may generate a full metric distribution for a candidate model by measuring the MSE, MAE, and R2 for the candidate model.

In one or more embodiments, generating the performance metrics for the candidate models includes applying a non-parametric bootstrap statistical method to generate the performance metrics. The system applies the non-parametric bootstrap statistical method by repeatedly resampling from the original dataset with replacement to simulate the sampling distribution of a performance metric. For example, the original dataset may be the test data that machine learning models are evaluated on. This is a “sample” from some larger population that the models will be applied to. The system resamples with replacement by randomly drawing data points from the test set to create new test sets of the same size. In this process, some data points will occur multiple times in resampled sets. Other data points may not occur. Performing the resampling process many times creates many variations (i.e., samples) of test sets even though they come from the original test data. The system determines the sampling distribution of performance metrics by determining how much the performance metric varies across the resampled test sets. In one or more embodiments, the resampling process simulates repeatedly collecting new test sets and evaluating model metrics on the different test sets. In addition to applying the non-parametric bootstrap statistical method, the system further takes the point estimate of the original test data to compute the set of performance metrics directly on the original test data.

The system fits the performance metrics to a statistical model including an influence factor to generate a distribution curve for a candidate application (Operation 208). The system further obtains a distribution curve for a corresponding stable application. Obtaining the distribution curve for a corresponding stable application may include retrieving performance metric data and/or the distribution curve from a data storage device. Alternatively, obtaining the distribution curve for a corresponding stable application may include calculating performance metrics and fitting the performance metrics to the statistical model.

In one or more embodiments, the system fits the performance metric to a statistical model by performing null hypothesis testing on the metrics data. The null hypothesis testing quantifies the likelihood that changes to the application generating code module, as represented by candidate application performance metrics, are statistically significant. In other words, the null hypothesis testing quantifies if the changes to the application generating code model result in performance metrics changes that are more than just the noise that would result from random changes to the application generating code module. The stable state, or current state, of the application generating code module is represented by a set of performance metrics that correspond to stable applications such applications currently implemented in an execution environment.

In one or more embodiments, the system fits the performance metric data to a Bayesian-type statistical model that includes a parameter (referred to in the present specification as influence factor, M) that modifies a distribution of the performance metric data to convert a change in the shape of the distribution from (a) around a center of the performance metric distribution to (b) a shift of the center of the performance metric distribution toward a clustering of measured performance metric values. In embodiments, the influence factor, M, represents a correlation between the performance improvement (or deterioration) of a set of applications under test and a corresponding set of stable applications.

An example of a Bayesian statistical model with the influence factor, M, is described below. From the performance metrics corresponding to a set of candidate applications and a corresponding set of stable applications, the system calculates the following values: θ and z.

θᵢ* represents multiple differences between metric samples of a candidate application and metric samples of a stable application as computed on the re-sampled test sets. [symbol] represents the difference between the point estimate of the candidate application and the point estimate of the stable application as computed on the original test set.

Z represents a set of performance metric data. A Z score for a set of performance metric data, i, may be calculated by the following equation:

$${z}_{i} = \frac{{\hat{θ}}_{ι}}{STD ( {θ}_{i}^{*} )} .$$

A null hypothesis test is represented by the following equation, where μ represents a real change, defined as a change that is statistically significant:

$${H}_{0}^{( i )} \text{:} {μ}_{i} = 0 vs {H}_{A}^{( i )} : {μ}_{i} \neq 0 .$$

The statistical model is represented by the following equations:

$${z}_{i} ∼ N ( ( 1 - {γ}_{i} ) {μ}_{i} , 1 ) ;$$

$${γ}_{i} ∼ Bern ( p ) ;$$

$$p ∼ f ( p ) ;$$

$${μ}_{i} ∼ N ( M , τ ) ;$$

$$M ∼ N ( 0 , 1 ) ;$$

$${τ}^{2} \sim 1 / ( 1 + {τ}^{2} ) .$$

In the above example, the parameter, M, represents the influence factor. The influence factor, M, modifies the statistical model by converting a change in the shape of the distribution from (a) around a center of the performance metric distribution to (b) a shift of the center of the performance metric distribution toward a clustering of measured performance metric values. The influence factor, M, represents a correlation between the performance improvement (or deterioration) of a set of applications under test and a corresponding set of stable applications. For example, a system may generate applications for clients A and B. A developer proposes a modification to a set of application-generation code that generates the applications. The system obtains the performance metrics for the applications currently in use and generates performance metrics for the candidate applications based on the proposed modifications to the application-generating code. The influence factor represents the correlation between the improvement for the application associated with customer A and the application associated with customer B.

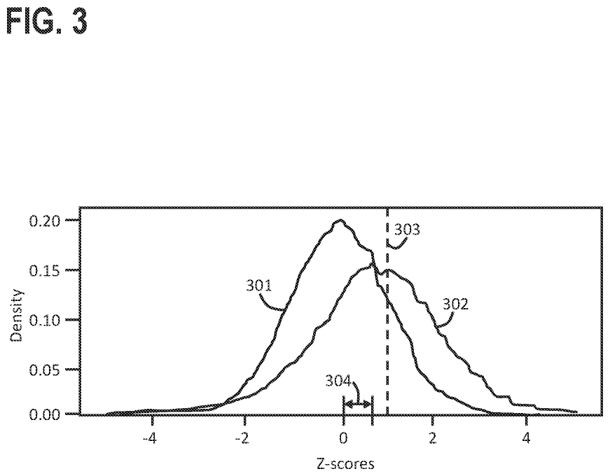

Based on fitting the z-scores to the statistical model to generate a posterior distribution, the system compares a distribution for the performance metrics for a candidate application with a distribution for the performance metrics for a corresponding stable application (Operation 210). FIG. 3 illustrates an example of a comparison of distributions. Distribution 301 represents a performance metric distribution associated with a stable application. Distribution 302 represents a performance metric distribution associated with a candidate application. Dashed line 303 represents a z-score corresponding to a set of performance metric values for the set of candidate applications. For example, dashed line 303 may represent an average, a mean, or a clustering of z-scores for performance metrics corresponding to the distribution 302. The distance, 304, represents a shift in a location of the peak of the distribution 302 based on the inclusion of the influence factor, M, in the statistical model used to generate the distributions 301 and 302. In other words, fitting the performance metric data for the candidate application to the statistical model excluding the influence factor, M, would result in a distribution (not shown) centered around zero and flattened relative to the distribution 301, so a peak of the distribution would be lower than the peak of the distribution 301.

The system determines, based on the comparison, if the modeled modification to the application generating code module meets implementation criteria (Operation 212). The implementation criteria may specify that (a) a candidate distribution is an improvement over a stable application, and (b) the measured improvement is statistically significant. For example, the system may determine if a set of z-scores associated with an application compatible with a null distribution (i.e., the stable application distribution) or the alternative distribution (i.e., the candidate application distribution). Referring to FIG. 3, determining if the modeled modification to the application generating code module meets implementation criteria may include determining (a) if the dashed line 303 crosses the distribution 302 within the distribution 301 or external to the distribution 301 and (b) if the distance 304 exceeds a threshold distance. In other words, determining if the modeled modification to the application generating code module meets implementation criteria may include determining if the density value for a particular z score corresponding to a particular performance metric is higher for the candidate application or the stable application.

Based on determining the modeled modification to the application generating code does not meet the implementation criteria, the system refrains from implementing the modification to the application-generating code (Operation 214). The system may generate a notification to a source device requesting the modification to notify the source device that the requested modification does not meet the implementation criteria. The system may discard the requested or proposed modification from among a set of candidate modifications.

Based on determining the modeled modification to the application generating code meets the implementation criteria, the system implements the modification to the application-generating code (Operation 216). According to one example, the system replaces a current set of applications with a new set of applications generated by the modified application generating code module. As another example, the system may store a set of modified applications generated by a set of modified application generating code in a data repository. The system may implement the applications stored in the repository in an execution environment at a predefined time. For example, the system may update applications for clients at predefined intervals such as monthly. Alternatively, the system may push sets of modified applications to client devices to replace currently executing applications based on achieving predefined performance improvement values. As an example, the system may refrain from pushing modified applications to client devices to replace currently executing applications until the modified applications correspond to at least a 5% improvement across a set of performance metrics.

The system determines if an additional candidate modification to the application generating code module has been received (Operation 218). If a candidate modification has been received, the system models the modification (Operation 202). In one or more embodiments, the system iteratively tests candidate modifications to application-generating code by iteratively comparing candidate application models against stable applications stored in a data repository to tune and improve the performance of the application-generating code. The system may repeatedly receive, model, and store candidate modifications to application generating code in a data store. The system may refrain from pushing modified applications generated based on the modified application generating code to client devices to replace currently executing applications until the combination of iteratively applied modifications to the candidate applications correspond to at least a predefined improvement (such as a 5% or 10% improvement) across a set of performance metrics.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

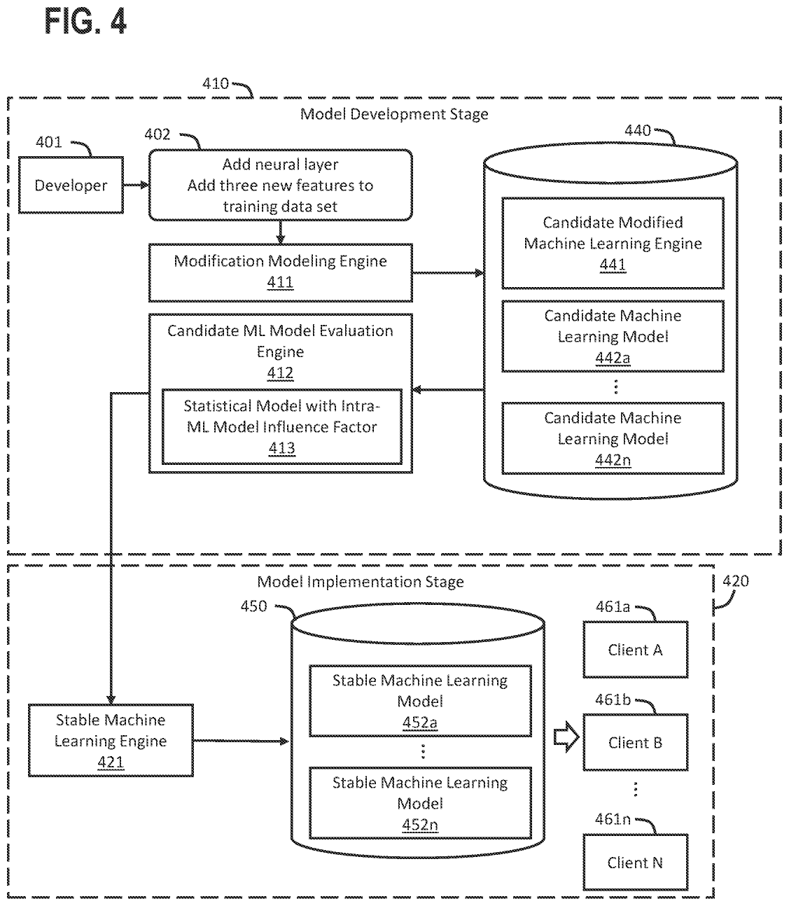

FIG. 4 illustrates a model development state 410 and a model implementation stage 420 for developing and implementing machine learning models for a set of clients 461a-461n. A stable machine learning engine 421 trains a set of stable machine learning models 452a-452n for use by the clients 461a-461n. The data repository 450 stores the models 452a-452n.

In some examples, one or more elements of the stable machine learning engine 421 may use a machine learning algorithm to identify one or both user actions and task operations based on image data content. A machine learning algorithm is an algorithm that can be iterated to learn a target model/that best maps a set of input variables to an output variable using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes datasets and associated labels. The datasets are associated with input variables for the target model f. The associated labels are associated with the output variable of the target model f. The training data may be updated based on, for example, feedback on the accuracy of the current target model f. Updated training data is fed back into the machine learning algorithm that in turn updates the target model f.

A machine learning algorithm generates a target model f, so the target model f best fits the datasets of training data to the labels of the training data. Additionally, or alternatively, a machine learning algorithm generates a target model f, so when the target model f is applied to the datasets of the training data, a maximum number of results determined by the target model f matches the labels of the training data.

In an embodiment, a machine learning algorithm can be iterated to learn correlations between sets of input data and output values. In an example, the system initially trains a neural network using a historical data set. Training the neural network includes generating n hidden layers for the neural network and the functions/weights applied to a hidden layer to compute the next hidden layer. The training may further include determining the functions/weights to be applied to the final, n-th hidden layer that computes the final label(s) or prediction(s) for a data point.

Training a neural network includes the following: (a) obtaining a training data set, (b) iteratively applying the training data set to a neural network to generate labels for data points of the training data set, and (c) adjusting weights and offsets associated with the formulae that make up the neurons of the neural network based on a loss function that compares values associated with the generated labels to values associated with test labels. The neurons of the neural network include activation functions to specify bounds for a value output by the neurons. The activation functions may include differentiable nonlinear activation functions, such as rectified linear activation (ReLU) functions, logistic-type functions, or hyperbolic tangent-type functions. A neuron receives the values of the neuron of the previous layer, applies a weight to the value of the previous layer, and applies one or more offsets to the combined values of the previous layer. The activation function constrains a range of possible output values from a neuron. A sigmoid-type activation function converts the neuron value to a value between 0 and 1. A ReLU-type activation function converts the neuron value to 0 if the neuron value is negative and to the output value if the neuron value is positive. The ReLU-type activation function may also be scaled to output a value between 0 and 1. For example, after applying weights and an offset value to the values from the previous layer for one neuron, the system may scale the neuron value to a value between −1 and +1. The system may then apply the ReLU-type activation function to generate a neuron output value between 0 and 1. The system trains the neural network using the training data set, a test data set, and a verification data set until the labels generated by the trained neural network are within a specified level of accuracy such as 98% accuracy.

The clients 461a-461n may access models 452a-452n in a cloud environment. Alternatively, the clients 461a-461n may store copies of the models 452a-452n locally. The clients 461a-461n provide input data to the models 452a-452n to generate output predictions, classifications, and/or or rankings.

A developer 401 generates recommendations 402 for modifying the machine learning engine. In the example embodiment, the recommendations include modifying the machine learning engine to add a neural layer to neural network machine learning models generated by the machine learning engine. The recommendations further include adding three new features to a training data set used to train the neural networks.

The modification modeling engine 411 generates a candidate modified machine learning engine 441 configured to (a) add a neural layer to neural network machine learning models generated by the machine learning engine and (b) add three new features to a training data set used to train neural networks. The modification modeling engine 411 applies sets of training data to the candidate modified machine learning engine 440 to train a set of candidate machine learning models 442a-442n.

The candidate machine learning model evaluation engine 412 generates performance metrics for the candidate machine learning models 442a-442n. The candidate machine learning model evaluation engine 412 generates multiple different metrics for the same test data set and the same candidate model to generate sets of full metric distributions. For example, the candidate machine learning model evaluation engine 412 generates a full metric distribution for the candidate machine learning model 442a by measuring the accuracy, precision, recall, F1 score, and AUC-ROC.

The candidate machine learning model evaluation engine 412 applies a non-parametric bootstrap statistical method to generate the performance metrics. The candidate machine learning model evaluation engine 412 applies the non-parametric bootstrap statistical method by repeatedly resampling from the original dataset of test data with replacement to simulate the sampling distribution of a performance metric. By performing the resampling process many times, the candidate machine learning model evaluation engine 412 creates many variations (i.e., samples) of test sets that come from the original test data. The system determines the sampling distribution of performance metrics by determining how much the performance metric varies across the resampled test sets. In addition to applying the non-parametric bootstrap statistical method, the candidate machine learning model evaluation engine 412 further takes the point estimate of the original set of test data to compute the set of performance metrics directly on the original test data set.

The candidate machine learning model evaluation engine 412 fits the performance metrics to a statistical model, including an inter-machine learning model influence factor, to generate a distribution curve for a candidate model 442a. The candidate machine learning model evaluation engine 412 further obtains a distribution curve for a corresponding stable model 452a. The candidate machine learning model evaluation engine 412 accesses the distribution curve for the stable model 452a from a data repository.

The candidate machine learning model evaluation engine 412 performs null hypothesis testing on the metrics data to fit the performance metrics data to the statistical model. The null hypothesis testing quantifies the likelihood that changes to the machine learning engine are statistically significant.

The candidate machine learning model evaluation engine 412 fits the performance metric data to a Bayesian-type statistical model 413 that includes an inter-model influence factor, M. The inter-model influence factor modifies a distribution of the performance metric data to convert a change in the shape of the distribution from (a) around a center of the performance metric distribution to (b) a shift of the center of the performance metric distribution toward a clustering of measured performance metric values. The inter-model influence factor, M, represents a correlation between the performance improvement (or deterioration) of a set of models under test and a corresponding set of stable models.

The candidate machine learning model evaluation engine 412 compares a distribution for the performance metrics for the candidate model 442a with a distribution for the performance metrics for a corresponding stable model 452a. Based on determining that the distribution for the candidate model 442a (a) is an improvement over the distribution for the stable model 452a, and (b) the measured improvement is statistically significant, the candidate model evaluation engine 412 designates the candidate modified machine learning model 441 as a stable machine learning engine.

The candidate machine learning model evaluation engine 412 determines a quantitative improvement of the candidate modified machine learning engine 441 over the previous stable machine learning engine 421. Based on determining that the improvement is a 5% improvement, the system compares the improvement to a threshold for replacing the previous stable machine learning engine 421. Based on determining the threshold is 10%, the candidate machine learning model evaluation engine 412 refrains from replacing the previous stable machine learning engine 421 with the candidate modified machine learning engine 441. Instead, the modification modeling engine 441 receives additional modifications and generates additional models based on the modifications. The modification modeling engine 411 and candidate machine learning model evaluation engine 412 iteratively (a) model modifications to a machine learning engine and (b) evaluate the modifications based on the statistical model until the candidate machine learning model evaluation engine 412 determines the cumulative improvements amount to at least a 10% improvement in performance metrics. Once the cumulative improvement exceeds the threshold, the candidate machine learning model evaluation engine 412 replaces the previous stable machine learning engine 421 with the cumulatively modified machine learning engine as the new stable machine learning engine 421. The system further applies a set of training data to the new stable machine learning engine 421 to generate a set of new stable machine learning models 452a-452n.

### 5. Practical Applications, Advantages, and Improvements

In application execution environments, applications may generate different output values based on the sets of input values provided to the applications. For example, in a cloud-based machine learning environment, multiple clients may store and use machine learning models generated by the same machine learning engine. The different clients may be associated with different input data characteristics. For example, one client may use a machine learning model to predict the shopping behavior of one demographic (such as youth). Another client may use the machine learning model to predict the shopping behavior of another demographic (such as the elderly). Other demographics include race, gender, geographic locations, and income levels. When developers that manage the cloud environment including the machine learning engine want to modify cloud services, such as modifying the features used to train machine learning models, the developers may not be able to readily determine (a) if observed changes to performance metrics are statistically significant or merely statistical noise, (b) if the observed changes would translate across all applications (such as across all implementations of a machine learning model for different clients and different demographics), and (c) if observed changes to one metric would correspond to similar changes in other performance metrics. Without being able to determine these criteria, developers may not determine the effectiveness of proposed changes to an application-generation module, absent extensive testing on many applications using many performance metrics.

One or more embodiments improve conventional methods of determining the effectiveness of changes to an application-generation module, such as a machine learning engine that trains machine learning models by computing a full distribution of a metric using non-parametric statistics and fitting the non-parametric statistics to a Bayesian model including an influence factor. The method provides for automation of an evaluation process by allowing a system to repeatably compare current and experimental versions of an application-generation code module in a repeatable way using a CI/CD pipeline. The methods provide for generality in performance metrics. Different performance metrics have different statistical properties. The methods herein provide non-parametric statistics to support a range of different performance metrics. The methods herein evaluate multiple sub-populations with one Bayesian model, that includes an influence factor.

One or more embodiments improve existing systems for forecasting, error correction and detection, and message filtering. For example, an enterprise may implement a sales forecasting system. The enterprise maintains a development environment to continually improve a forecast-model-generating code module based on new data, current sales trends, and the like. The enterprise may provide forecasting models to a variety of customers in a variety of industries. As new models are trained, the system pushes model updates to the clients' local computing systems. As the enterprise continually modifies and updates the forecast-model-generating code module, the enterprise (a) generates non-parametric statistics data based on measured performance metrics, and (b) fits the non-parametric statistics data to a Bayesian statistical model with an influence factor. If the enterprise determines the candidate changes are positive and statistically significant, the enterprise schedules the changes to be pushed to its clients in the next update.

Similarly, in the context of error correction and detection, an enterprise may train models (data models or machine learning models) to identify errors in data streams for different clients accessing and/or transmitting different types of data. The Bayesian-based methods described herein may detect and reconstruct corrupted text or media files by comparing them to statistical models of how data is structured. As another example, in the context of message filtering, a system may generate statistical models for many different clients that classify emails as spam or not spam based on the email contents and metadata. As more emails are observed, the system updates the code used to train the models using the Bayesian methods described herein to improve spam probability estimates.

While the above practical applications, advantages, and improvements are provided by way of example, embodiments are not limited to these practical applications, advantages, and improvements.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, such as machine learning models, that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use the same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with the same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with the same tenant ID.

As an example, each machine learning model implemented by a multi-tenant computer network may be tagged with a tenant ID. Only a tenant associated with the corresponding tenant ID may access the particular machine learning model. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access different applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

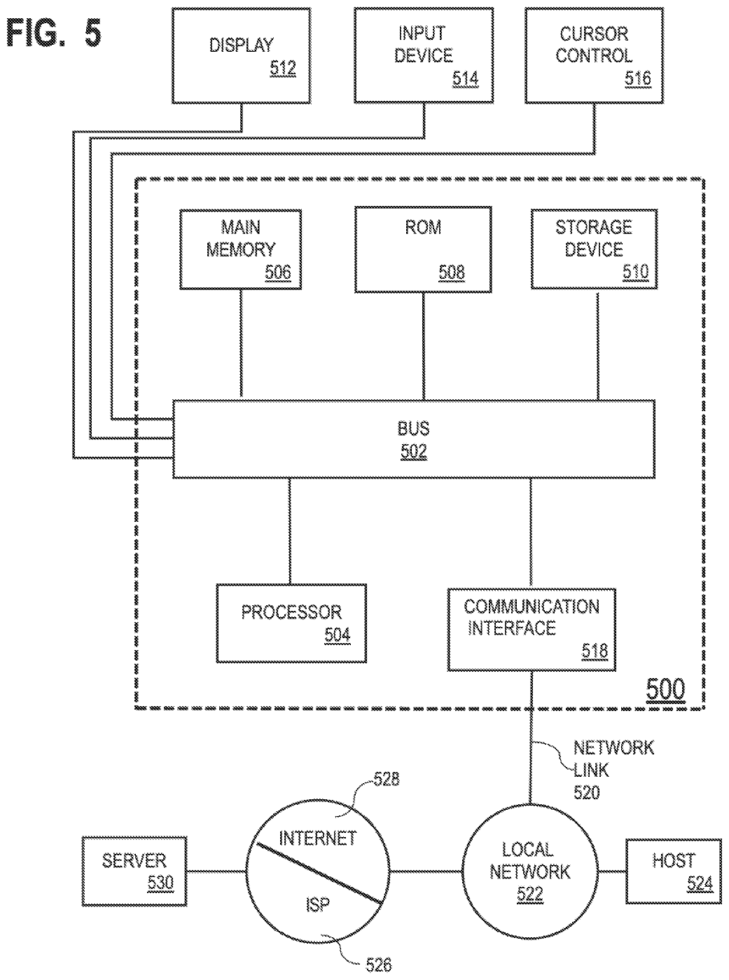

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read-only memory (ROM) 508 or other static storage device coupled to bus 502 for storing static information and instructions for processor 504. A storage device 510, such as a magnetic disk, optical disk, or a Solid-State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic that in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, that carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
modifying a first version of application-generating code to generate a second version of the application-generating code;
determining a performance of the second version of the application-generating code at least by:
obtaining a first set of performance metric values based on executing a first application generated by the first version of the application-generating code;
generating a first distribution representing the first set of performance metrics;
obtaining a second set of performance metric values based on executing a second application generated by the second version of the application-generating code;
generating a second distribution representing the second set of performance metrics, wherein generating the second distribution includes fitting the second set of performance metrics to a statistical model including an influence factor that corresponds to a shift of the center of the second distribution towards a clustering of the second set of performance metric values; and
based on the first distribution and the second distribution, determining an improvement value representing an improvement in performance between the first version of the application-generating code and the second version of the application-generating code;
based on determining that the improvement value meets one or more implementation criteria, performing at least one of:
replacing, in an application-execution environment, the first application with the second application; and
generating, in the application-execution environment, a third application using the second version of the application-generating code.

2. The one or more non-transitory computer readable media of claim 1, wherein determining the improvement value comprises identifying an intersection region where a line corresponding to a z-score associated with the second set of performance metric values intersects the second distribution.

3. The one or more non-transitory computer readable media of claim 1, wherein the first application and the second application are machine learning models, and
wherein the second version of the application-generating code is a machine learning engine that trains the machine learning models.

4. The one or more non-transitory computer readable media of claim 3, wherein modifying the first version of the application-generating code to generate the second version of the application-generating code comprises at least one of:
adding a new feature to a set of features used to train the machine learning models;
removing a feature from among the set of features used to train the machine learning models; and
changing a weight applied to a feature from among the set of features used to train the machine learning models.

5. The one or more non-transitory computer readable media of claim 1, wherein the influence factor modifies the statistical model by converting a portion of a change in shape of the second distribution around a center of the second distribution into a shift of the center of the second distribution towards a clustering of the second set of performance metric values.

6. The one or more non-transitory computer readable media of claim 1, wherein the performance criteria comprise:
a first threshold corresponding to a magnitude of a change; and
a second threshold corresponding to a quality of the change.

7. The one or more non-transitory computer readable media of claim 1, wherein the performance metrics include an estimated time difference between a first time required to perform a particular set of operations using second application and a second time required to perform the particular set of operations using the first application.

8. A method comprising:
modifying a first version of application-generating code to generate a second version of the application-generating code;
determining a performance the second version of the application-generating code at least by:
obtaining a first set of performance metric values based on executing a first application generated by the first version of the application-generating code;
generating a first distribution representing the first set of performance metrics;
obtaining a second set of performance metric values based on executing a second application generated by the second version of the application-generating code;
generating a second distribution representing the second set of performance metrics, wherein generating the second distribution includes fitting the second set of performance metrics to a statistical model including an influence factor that corresponds to a shift of the center of the second distribution towards a clustering of the second set of performance metric values; and
based on the first distribution and the second distribution, determining an improvement value representing an improvement in performance between the first version of the application-generating code and the second version of the application-generating code;
based on determining that the improvement value meets one or more implementation criteria, performing at least one of:
replacing, in an application-execution environment, the first application with the second application; and
generating, in the application-execution environment, a third application using the second version of the application-generating code,
wherein the method is performed by at least one device including a hardware processor.

9. The method of claim 8, wherein determining the improvement value comprises identifying an intersection region where a line corresponding to a z-score associated with the second set of performance metric values intersects the second distribution.

10. The method of claim 8, wherein the first application and the second application are machine learning models, and
wherein the second version of the application-generating code is a machine learning engine that trains the machine learning models.

11. The method of claim 10, wherein modifying the first version of the application-generating code to generate the second version of the application-generating code comprises at least one of:
adding a new feature to a set of features used to train the machine learning models;
removing a feature from among the set of features used to train the machine learning models; and
changing a weight applied to a feature from among the set of features used to train the machine learning models.

12. The method of claim 8, wherein the influence factor modifies the statistical model by converting a portion of a change in shape of the second distribution around a center of the second distribution into a shift of the center of the second distribution towards a clustering of the second set of performance metric values.

13. The method of claim 8, wherein the performance criteria comprise:
a first threshold corresponding to a magnitude of a change; and
a second threshold corresponding to a quality of the change.

14. The method of claim 8, wherein the performance metrics include an estimated time difference between a first time required to perform a particular set of operations using second application and a second time required to perform the particular set of operations using the first application.

15. A system comprising:
one or more processors; and
memory storing instructions that, when executed by the one or more processors, cause the system to perform operations comprising:
modifying a first version of application-generating code to generate a second version of the application-generating code;
determining a performance the second version of the application-generating code at least by:
obtaining a first set of performance metric values based on executing a first application generated by the first version of the application-generating code;
generating a first distribution representing the first set of performance metrics;
obtaining a second set of performance metric values based on executing a second application generated by the second version of the application-generating code;
generating a second distribution representing the second set of performance metrics, wherein generating the second distribution includes fitting the second set of performance metrics to a statistical model including an influence factor that corresponds to a shift of the center of the second distribution towards a clustering of the second set of performance metric values; and
based on the first distribution and the second distribution, determining an improvement value representing an improvement in performance between the first version of the application-generating code and the second version of the application-generating code;
based on determining that the improvement value meets one or more implementation criteria, performing at least one of:
replacing, in an application-execution environment, the first application with the second application; and
generating, in the application-execution environment, a third application using the second version of the application-generating code.

16. The system of claim 15, wherein determining the improvement value comprises identifying an intersection region where a line corresponding to a z-score associated with the second set of performance metric values intersects the second distribution.

17. The system of claim 15, wherein the first application and the second application are machine learning models, and
wherein the second version of the application-generating code is a machine learning engine that trains the machine learning models.

18. The system of claim 17, wherein modifying the first version of the application-generating code to generate the second version of the application-generating code comprises at least one of:
adding a new feature to a set of features used to train the machine learning models;
removing a feature from among the set of features used to train the machine learning models; and
changing a weight applied to a feature from among the set of features used to train the machine learning models.

19. The system of claim 15, wherein the influence factor modifies the statistical model by converting a portion of a change in shape of the second distribution around a center of the second distribution into a shift of the center of the second distribution towards a clustering of the second set of performance metric values.

20. The system of claim 15, wherein the performance criteria comprise:
a first threshold corresponding to a magnitude of a change; and
a second threshold corresponding to a quality of the change.
